(19) United States
(12) Patent Application Publication
(10) Pub. No.: US 2026/0181356 A1
(43) Pub. Date: Jun. 25, 2026

(54) ONLINE DETECTION OF SMARTPHONE USER'S PRIMARY LOCATION

(71) Applicant: Samsung Electronics Co., Ltd., Suwon-si (KR)

(72) Inventors: Neha Dawar, McKinney, TX (US); Rebal Al Jurdi, Allen, TX (US); Abhishek Sehgal, Frisco, TX (US); Yuming Zhu, Plano, TX (US); Junsu Choi, Siheung-si (KR)

(21) Appl. No.: 19/428,001

(22) Filed: Dec. 19, 2025

Related U.S. Application Data
(60) Provisional application No. 63/738,440, filed on Dec. 23, 2024.

(51) Int. Cl. H04W 4/029; H04W 4/021

(52) U.S. Cl. CPC H04W 4/029; H04W 4/021

(57) ABSTRACT

Apparatuses and methods for an online detection of smartphone user's indoor location. A method of a network entity comprises: receiving, from a user equipment (UE), geolocation measurement information; identifying stay points based on the geolocation measurement information, wherein the geolocation measurement information is received at a non-uniform dynamic rate associated with a motion of a user; determining, based on the geolocation measurement information, whether a number of stay points exceeds a threshold; and generating user location clusters based on a determination that the number of stay points exceeds the threshold.

### CROSS-REFERENCE TO RELATED APPLICATIONS AND CLAIM OF PRIORITY

The present application claims priority to U.S. Provisional Patent Application No. 63/738,440, filed on Dec. 23, 2024. The contents of the above-identified patent documents are incorporated herein by reference.

### TECHNICAL FIELD

The present disclosure relates generally to a location detection and, more specifically, the present disclosure relates to an online detection of smartphone user's primary location.

### BACKGROUND

Due to the development of smart sensing technologies, sensor-based user spatial context detection has gained increasing popularity in human-computer interaction applications. Detecting the spatial context refers to identifying the geographical location of the user. A modern-day smartphone has access to a vast variety of sensors allowing on-the-go spatial or location context detection. Online location detection can be used to understand the user's behaviors and patterns, that is understanding if there is any specific application or action the user performs on the smartphone based on the location. For example, there could be a certain phone application that the user uses when they enter a specific geographical area (e.g., open a multimedia streaming app in the gym, or a particular shopping app when entering the particular store's building), or a certain setting or action that the user performs on the smartphone when they enter a specific geographical area (e.g., put the phone on silent when entering a conference room of the office). Understanding the user behaviors and patterns can be beneficial for a variety of applications and services, which includes recommending suitable applications or settings based on user's habits. In the present disclosure, a solution to perform online location clustering and detection using various sensors available in the smartphone is provided.

### SUMMARY

The present disclosure relates to an online detection of smartphone user's primary location.

In one embodiment, a network entity in a wireless communication system is provided. The network entity comprises a transceiver configured to receive, from a user equipment (UE), geolocation measurement information. The network entity further comprises a processor operably coupled to the transceiver, the processor configured to: identify stay points based on the geolocation measurement information, wherein the geolocation measurement information is received at a non-uniform dynamic rate associated with a motion of a user; determine, based on the geolocation measurement information, whether a number of stay points exceeds a threshold; and generate user location clusters based on a determination that the number of stay points exceeds the threshold.

In another embodiment, a method of a network entity in a wireless communication system is provided. The method comprises: receiving, from a UE, geolocation measurement information; identifying stay points based on the geolocation measurement information, wherein the geolocation measurement information is received at a non-uniform dynamic rate associated with a motion of a user; determining, based on the geolocation measurement information, whether a number of stay points exceeds a threshold; and generating user location clusters based on a determination that the number of stay points exceeds the threshold.

In yet another embodiment, a UE in a wireless communication system is provided The UE comprises a processor configured to generate geolocation measurement information, wherein stay points are identified based on the geolocation measurement information. The UE further comprises a transceiver operably coupled to the processor, the transceiver configured to transmit, to a network entity, the geolocation measurement information, wherein the geolocation measurement information is transmitted at a non-uniform dynamic rate associated with a motion of a user, wherein whether a number of stay points exceeds a threshold is determined based on the geolocation measurement information, and wherein user location clusters is identified based on a determination that the number of stay points exceeds the threshold.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of a communication system according to various embodiments of the present disclosure;

FIG. 2 illustrates an example of an electronic device according to various embodiments of the present disclosure;

FIG. 3 illustrates an example of a network entity according to various embodiments of the present disclosure;

FIG. 4 illustrates an example of primary location clustering according to various embodiments of the present disclosure;

FIG. 5 illustrates an example of stay point according to various embodiments of the present disclosure;

FIG. 6 illustrates a flowchart of a method for online stay point detection according to various embodiments of the present disclosure;

FIG. 7 illustrates an example of POI using the centroid of stay points and the radius according to various embodiments of the present disclosure;

FIG. 8 illustrates an example of new measurement with distance from the centroid of the POI less than its radius according to various embodiments of the present disclosure;

FIG. 9 illustrates an example of new geolocation measurement merging into the POI when only centroid and radius are stored as representative of the POI according to various embodiments of the present disclosure;

FIG. 10 illustrates an example of new geolocation measurement merging into the POI when the stay points along with the centroid and radius are stored as representative of the POI according to various embodiments of the present disclosure;

FIG. 11 illustrates a flowchart of a method for an online primary location clustering and detection solution that stores only the centroids and radius of the stay points as representatives of POI according to various embodiments of the present disclosure;

FIG. 12 illustrates a flowchart of a method for an online primary location clustering and detection solution that stores the stay points along with their centroids and radius as representatives of POI according to various embodiments of the present disclosure;

FIG. 13 illustrates an example of criteria to merge the POIs according to various embodiments of the present disclosure; and

FIG. 14 illustrates a flowchart of a method for an online detection of smartphone user's primary location according to various embodiments of the present disclosure.

### DETAILED DESCRIPTION

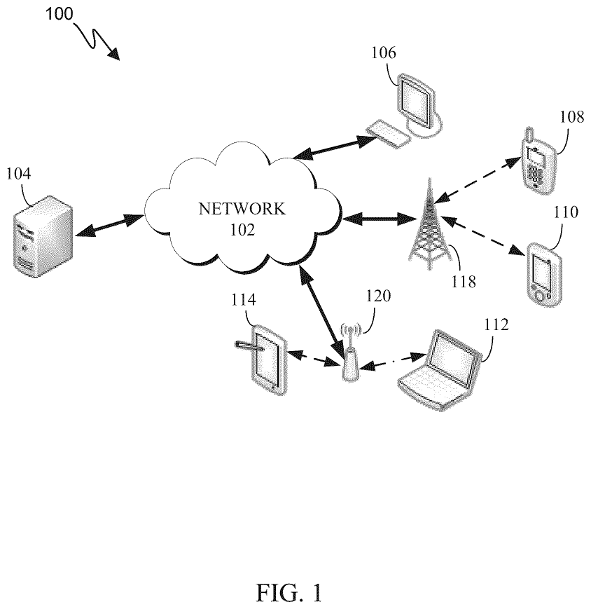

FIGS. 1-14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

In many cases, the solutions perform offline user's spatial context clustering and detection when all the data is available. There is a need for online spatial context detection on the smartphones to enable real-time personalized suggestions and recommendations based on the context.

FIG. 1 illustrates an example of a communication system 100 in accordance with this disclosure. The embodiment of the communication system 100 shown in FIG. 1 is for illustration only. Other embodiments of the communication system 100 can be used without departing from the scope of this disclosure.

As shown in FIG. 1, the communication system 100 includes a network 102 that facilitates communications between various components in the communication system 100. For example, the network 102 can communicate internet protocol (IP) packets, frame relay frames, asynchronous transfer mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-114. The client devices 106-114 may be, for example, a smartphone, a tablet computer, a laptop, a personal computer, a TV, an interactive display, a wearable device, or a HMD. For certain embodiment, the client devices 106-114 may have various sensors allowing on-the-go spatial or location context detection. The server 104 can represent one or more servers. Each server 104 includes any suitable computing or processing device that can provide computing services for one or more client devices, such as the client devices 106-114. Each server 104 could, for example, include one or more processing devices, one or more memories storing instructions and data, and one or more network interfaces facilitating communication over the network 102. As described in more detail below, the server 104 can transmit a compressed bitstream, representing a point cloud or mesh, to one or more display devices, such as a client device 106-114.

In certain embodiment, the client devices 106-114 (e.g., a UE) support an operation for an online detection of smartphone user's primary location performed by a network device (e.g., 118 and 120 as illustrated in FIG. 1).

Each client device 106-114 represents any suitable computing or processing device that interacts with at least one server (such as the server 104 as illustrated in FIG. 1) or other computing device(s) over the network 102. The client devices 106-114 include an electronic device performing a sensing operation, a desktop computer 106, a mobile telephone or mobile device 108 (such as a smartphone), a personal digital assistant (PDA) 110, a laptop computer 112, and a tablet computer 114. However, any other or additional client devices could be used in the communication system 100. The client devices 106-114 may include sensing system that may be independently and/or individually implemented, which may communicate with the network 102 and/or each of the client devices 106-114.

Specifically, the client device 106-114 including a sensing system can communicate with the network entity 102 and/or the client devices 106-114 and/or communicate with the server 104, one or more base stations 118 (e.g., cellular base stations or eNodeBs (eNBs)), or one or more wireless access points 120 as illustrated in FIG. 1.

In certain embodiment, a network entity may be a base station (e.g., 118 as illustrated in FIG. 1). The network entity may support an online detection of smartphone user's primary location.

In this example, some client devices 106-114 communicate indirectly with the network 102. For example, the mobile device 108 and PDA 110 communicate via one or more base stations 118, such as cellular base stations or eNodeBs (eNBs). Also, the laptop computer 112, and the tablet computer 114 communicate via one or more wireless access points 120, such as IEEE 802.11 wireless access points. Note that these are for illustration only and that each client device 106-114 could communicate directly with the network 102 or indirectly with the network 102 via any suitable intermediate device(s) or network(s).

In certain embodiment, a network entity may be an access point (e.g., 120 as illustrated in FIG. 1). The network entity may support an online detection of smartphone user's primary location

In certain embodiments, any of the client devices 106-114 transmit information securely and efficiently to another device, such as, for example, the server 104. Also, any of the client devices 106-114 can trigger the information transmission between itself and the server 104.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

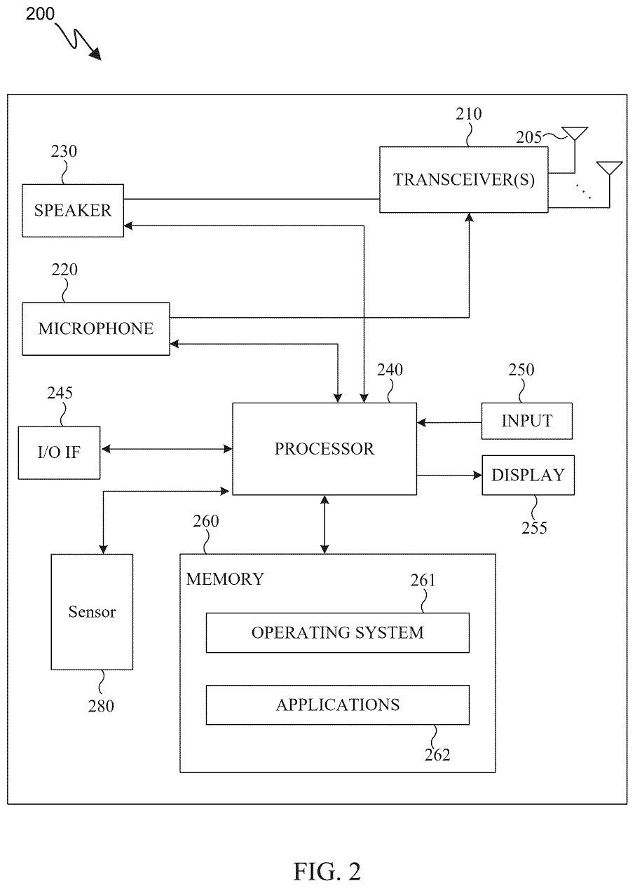

FIG. 2 illustrates an example of an electronic device 200 according to various embodiments of the present disclosure. The embodiment of the electronic device 200 (e.g., a UE, a smartphone, or client device 106-114 as illustrated in FIG. 1) is for illustration only, and the electronic device 200 could have the same or similar configuration. However, the electronic devices come in a wide variety of configurations, and FIG. 2 does not limit the scope of this disclosure to any particular implementation of a UE.

As shown in FIG. 2, the electronic device 200 (e.g., a smartphone, 106-114 as illustrated in FIG. 1) includes antenna(s) 205, a transceiver(s) 210, and a microphone 220. The electronic device 200 also includes a speaker 230, a processor 240, an input/output (I/O) interface (IF) 245, an input 250, a display 255, and a memory 260. The memory 260 includes an operating system (OS) 261 and one or more applications 262. The electronic device 200 further includes at least one sensor 280 to perform an online location clustering and detection using various sensors available in the electronic device (e.g., client device 106-114 as illustrated in FIG. 1).

The transceiver(s) 210 receives from the antenna 205, an incoming RF signal transmitted by a gNB of the network 100. The transceiver(s) 210 down-converts the incoming RF signal to generate an intermediate frequency (IF) or baseband signal. The IF or baseband signal is processed by RX processing circuitry in the transceiver(s) 210 and/or processor 240, which generates a processed baseband signal by filtering, decoding, and/or digitizing the baseband or IF signal. The RX processing circuitry sends the processed baseband signal to the speaker 230 (such as for voice data) or is processed by the processor 325 (such as for web browsing data).

TX processing circuitry in the transceiver(s) 210 and/or processor 240 receives analog or digital voice data from the microphone 220 or other outgoing baseband data (such as web data, e-mail, or interactive video game data) from the processor 240. The TX processing circuitry encodes, multiplexes, and/or digitizes the outgoing baseband data to generate a processed baseband or IF signal. The transceiver(s) 210 up-converts the baseband or IF signal to an RF signal that is transmitted via the antenna(s) 205.

The processor 240 can include one or more processors or other processing devices and execute the OS 261 stored in the memory 260 in order to control the overall operation of the electronic device 200. For example, the processor 240 could control the reception of DL channel signals and the transmission of UL channel signals by the transceiver(s) 210 in accordance with well-known principles. In some embodiments, the processor 240 includes at least one microprocessor or microcontroller.

The processor 240 is also capable of executing other processes and programs resident in the memory 260, such as processes to generate signals and/or information for supporting a primary location detection of the smartphone user in wireless communication systems.

The processor 240 can move data into or out of the memory 260 as required by an executing process. In some embodiments, the processor 240 is configured to execute the applications 262 based on the OS 261 or in response to signals received from gNBs or an operator. The processor 240 is also coupled to the I/O interface 245, which provides the electronic device 200 with the ability to connect to other devices, such as laptop computers and handheld computers. The I/O interface 245 is the communication path between these accessories and the processor 240.

The processor 240 is also coupled to the input 250 and the display 255m which includes for example, a touchscreen, keypad, etc., The operator of the electronic device 200 can use the input 250 to enter data into the electronic device 200. The display 255 may be a liquid crystal display, light emitting diode display, or other display capable of rendering text and/or at least limited graphics, such as from web sites.

The memory 260 is coupled to the processor 240. Part of the memory 260 could include a random-access memory (RAM), and another part of the memory 260 could include a Flash memory or other read-only memory (ROM).

Although FIG. 2 illustrates one example of electronic device 200, various changes may be made to FIG. 2. For example, various components in FIG. 2 could be combined, further subdivided, or omitted and additional components could be added according to particular needs. As a particular example, the processor 240 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 2 illustrates the electronic device 200 configured as a mobile telephone or smartphone, the electronic devices (e.g., client devices 106-114 as illustrated in FIG. 1) could be configured to operate as other types of mobile or stationary devices.

In certain embodiments, the electronic device 200 may perform, using at least one sensor 280, a sensor-based user spatial context detection that has gained increasing popularity in human-computer interaction applications. In certain embodiment, the electronic device 200 has access to a vast variety of sensors allowing on-the-go spatial or location context detection. In certain embodiment, the electronic device 200 performs an operation for online location clustering and detection using various sensors available in the smartphone.

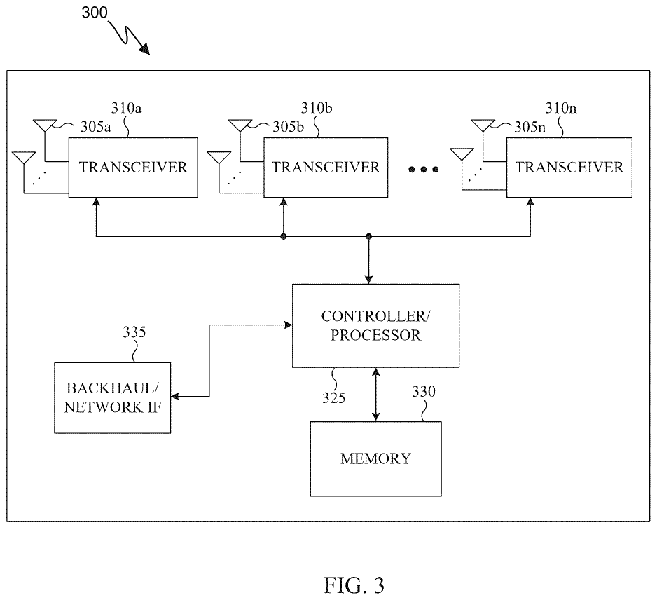

FIG. 3 illustrates an example of a network entity 300 according to various embodiments of the present disclosure. The embodiment of the network entity 300 illustrated in FIG. 3 is for illustration only, and the network entity 118 and 120 of FIG. 1 could have the same or similar configuration. However, the network entities come in a wide variety of configurations, and FIG. 3 does not limit the scope of this disclosure to any particular implementation of a network entity (e.g., base station (BS), gNB, NodeB).

As shown in FIG. 3, the network entity 300 (e.g., 118 and 120 as illustrated in FIG. 1) includes multiple antennas 305a-305n, multiple transceivers 310a-310n, a controller/processor 325, a memory 330, and a backhaul or network interface 335.

The transceivers 310a-310n receive, from the antennas 305a-305n, incoming RF signals, such as signals transmitted by a network entity (e.g., 118 and 120 as illustrated in FIG. 1, UEs) in the network 100. The transceivers 310a-310n down-convert the incoming RF signals to generate IF or baseband signals. The IF or baseband signals are processed by receive (RX) processing circuitry in the transceivers 310a-310n and/or controller/processor 325, which generates processed baseband signals by filtering, decoding, and/or digitizing the baseband or IF signals. The controller/processor 325 may further process the baseband signals.

Transmit (TX) 1 processing circuitry in the transceivers 310a-310n and/or controller/processor 325 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 310a-310n up-converts the baseband or IF signals to RF signals that are transmitted via the antennas 305a-305n.

The controller/processor 325 can include one or more processors or other processing devices that control the overall operation of the network entity 300. For example, the controller/processor 325 could control the reception of UL channel signals and the transmission of DL channel signals by the transceivers 310a-310n in accordance with well-known principles. The controller/processor 325 could support additional functions as well, such as more advanced wireless communication functions. For instance, the controller/processor 325 could support beam forming or directional routing operations in which outgoing/incoming signals from/to multiple antennas 305a-305n are weighted differently to effectively steer the outgoing signals in a desired direction. Any of a wide variety of other functions could be supported in the network entity (e.g., 118 and 120 as illustrated in FIG. 1) by the controller/processor 325.

The controller/processor 325 is also capable of executing programs and other processes resident in the memory 330, such as processes to support an online detection of smartphone user's primary location in a wireless communication network. The controller/processor 325 can move data into or out of the memory 230 as required by an executing process.

The controller/processor 325 is also coupled to the backhaul or network interface 335. The backhaul or network interface 335 allows the network entity 300 to communicate with other devices or systems over a backhaul connection or over a network. The interface 335 could support communications over any suitable wired or wireless connection(s). For example, when the network entity 302 is implemented as part of a wireless communication system (such as one supporting 5G/NR, LTE, or LTE-A), the interface 335 could allow the network entity 300 to communicate with other network entities over a wired or wireless backhaul connection. When the network entity 300 is implemented as an access point, the interface 335 could allow the network entity to communicate over a wired or wireless local area network or over a wired or wireless connection to a larger network (such as the Internet). The interface 335 includes any suitable structure supporting communications over a wired or wireless connection, such as an Ethernet or transceiver.

The memory 330 is coupled to the controller/processor 325. Part of the memory 330 could include a RAM, and another part of the memory 330 could include a Flash memory or other ROM. In certain embodiment, the controller/processor 325 support an online detection of smartphone user's primary location.

Although FIG. 3 illustrates one example of a network entity, various changes may be made to FIG. 3. For example, the network entity could include any number of each component shown in FIG. 3. Also, various components in FIG. 3 could be combined, further subdivided, or omitted and additional components could be added according to particular needs.

Haversine distance is used to calculate the distance between two points on a sphere using their latitudes and longitudes. If lat₁ and lon₁ respectively represent the latitude and longitude of point 1, and lat₂ and lon₂ represent that of point 2, the haversine distance is calculated using the following formula as shown in TABLE 1.

TABLE 1
Haversine distance
latDiff = lat₁ − lat₂
lonDiff = lon₁ − lon₂
$a = {sin}^{2} ( \frac{latDiff}{2} ) + cos ( {lat}_{1} ) cos ( {lat}_{2} ) {sin}^{2} ( \frac{lonDiff}{2} )$
distₕₐᵥ = 2 · r · atan2\sqrt{a,} \sqrt{1 − a})
where r is the radius of the earth.

In many cases, offline user's spatial context clustering and detection are performed when all the data is available. There is a need for online spatial context detection on the smartphones to enable real-time personalized suggestions and recommendations based on the context.

Location services play a key role in modern digital applications by enabling personalized and context-aware services. User's spatial context detection can be useful on a coarser level, for e.g., home region, work region, etc., or on a finer level, for e.g., zones within the home region (kitchen, living room, bedroom) or work region (conference room, cafeteria) or a combination of the two. A smartphone is generally equipped with GPS, Wi-Fi and IMU sensors. One or more of these may be used to detect the spatial context of the user.

A higher-level primary location detection can be performed using longer-range geolocation technologies, such as global navigation satellite system (GNSS) and cellular network, while a finer level indoor location detection can be performed using shorter-range wireless technologies such as Wi-Fi and Bluetooth. In the present disclosure, a solution is provided to online cluster and detect the primary location of the user using geolocation measurements. Clustering involves forming of primary location (or geofence) clusters, while detection performs inference of geolocation measurements to the formed geofence clusters.

In the present disclosure, following embodiments are provided.

In one embodiment, user location clusters is generated when a threshold amount of stay points are formed based on geolocation measurements, wherein a newly received geolocation measurement is utilized to infer with which user location cluster the newly received geolocation measurement is associated and wherein an outlier geolocation measurement is used to form a new stay point which is used to determine whether to perform re-clustering.

In one embodiment, stay points are formed based on the geolocation measurements, when the geolocation measurements are received at a non-uniform dynamic rate.

In one embodiment, real-time inference of geolocation measurements is provided to form new user location clusters, expand existing user location clusters, and merge user location existing clusters.

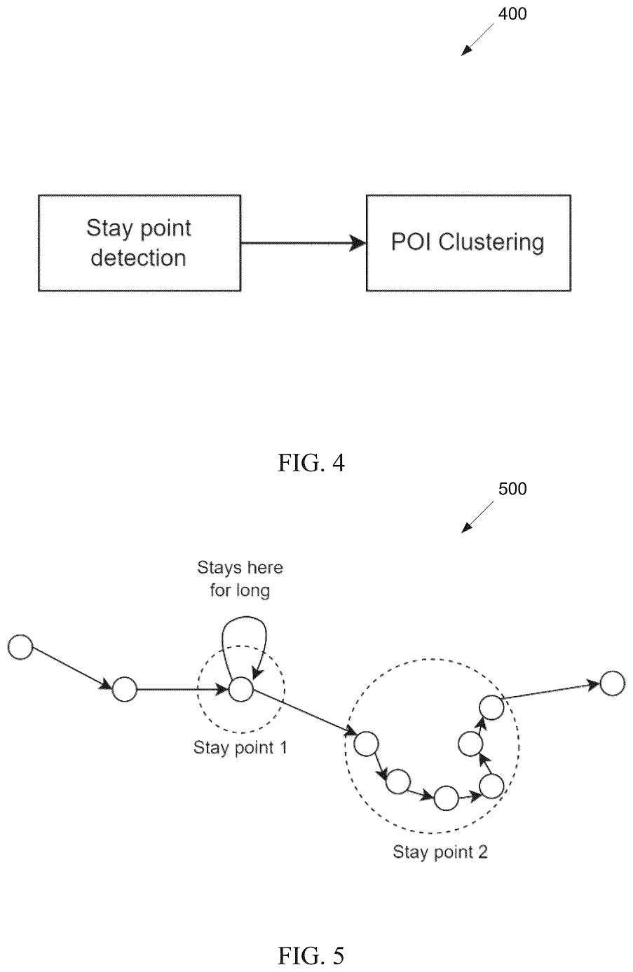

Geolocation measurements are obtained in terms of latitude and longitude. Throughout the day, the user can travel to multiple places thus accumulating geolocations over varied locations. Directly performing clustering over raw geolocation measurements can lead to formation of multiple clusters, including clusters of irrelevant locations. For spatial context, it is required to cluster only the locations where user spends considerable amount of time or visits frequently. These locations refer to as the points of interest (POIs). Hence, raw geolocation measurements are used to first obtain stay points from the measurements, which are then used in a clustering algorithm to obtain POIs of the user. The primary blocks used for location clustering are stay point detection and POI clustering as shown in FIG. 4.

FIG. 4 illustrates an example of primary location clustering 400 according to various embodiments of the present disclosure. An embodiment of the primary location clustering 400 shown in FIG. 4 is for illustration only.

A stay point refers to the geographical region where the user has stayed for a long period of time. A stay point is formed if the user remains stationary at a point for a time period exceeding a threshold (e.g., user sleeping in their bedroom, or user working on their desk in office), or the user wanders around the same point for a time period that is more than the threshold (e.g., user cooking a meal in the kitchen).

In one embodiment, a stay point detection algorithm is provided when the rate of receiving geolocation measurements is dynamic. If geolocation measurements are fetched too frequently at the same rate, it can be battery inefficient for the device. Hence, to conserve battery power, geolocation measurements can be fetched dynamically only when the location of the user changes with a minimum rate interval. In other words, if the user stays at the same location for too long, it can be represented by a single geolocation measurement. When the user moves away from this location, new geolocation measurements are fetched. When the user is in a walking or dynamic state, geolocation measurements are constantly obtained at a rate which is proportional to the speed of the user.

FIG. 5 illustrates an example of stay point 500 according to various embodiments of the present disclosure. An embodiment of the stay point 500 shown in FIG. 5 is for illustration only.

The pseudo code of the developed stay point detection algorithm is shown in TABLE 2. pᵢ refers to geolocation i represented by the latitude and longitude of the location. Firstly, the Haversine distance between two consecutive points is calculated and its ratio with the timestamp difference between the consecutive points is compared against a speed threshold theta_{dispt}. This may make sure that the user carrying the device is below a certain speed threshold. Stay points require the user to wander in a certain area, hence the user speed cannot exceed a threshold to form a stay point.

Geolocation measurements are iteratively added to the buffer to form a stay point. A point is added to the buffer if the distance between the current point and the earliest point in the buffer is below a threshold theta_{d} and the time difference between the current point and the earliest point in the buffer is above a threshold thetaₜ. If either of the following two conditions are satisfied, the buffer is cleared and buffering of points that qualify for stay points is restarted: (i) if the ratio of Haversine distance between two consecutive points and the timestamp difference between two consecutive points exceeds a threshold theta_{dispt}, or (ii) if the distance between the current point and the earliest point in the buffer is below a threshold theta_{d}.

For each stay point that is formed, the mean latitude and longitude of the points in the buffer that form this stay point are stored along with the arrival time (timestamp of the first point in the buffer) and departure time (timestamp of the last point in the buffer) of the stay point.

TABLE 2

```
Pseudo codes for developing stay point detection
procedure StayPointDetection
  StayPoints: = Ø
  i := 0
  j := 1
  while i < numPoints do
    disp := distance (pⱼ, pⱼ₋₁)
    deltaₜ := pⱼ · T − pⱼ₋₁ · T
    $if ( \frac{disp}{{delta}_{t}} ) > {theta}_{dispt} then$
    i := j
    continue
  end if
  dist := distance (pᵢ, pⱼ)
  if dist ≥ theta_{d} then
    i == j
  else if pⱼ · T − pᵢ · T > thetaₜ then
    S · mCoord: = ComputeMeanCoord ({pₖ|i ≤ k < j})
    S · arrT := pᵢ · T
    S · depT := pⱼ · T
    Add S to StayPoints
      i := j
    end if
    j := j + 1
  end while
  return StayPoints
end procedure
```

In case of dynamic rate for fetching geolocation measurements, it is possible that if the user is at the same location for too long (e.g., user sleeping on his bed for several hours), a geolocation measurement is received at the start of the stationary period at this location and next one is obtained after the user leaves this location. Although the user may be at this location for several hours, as per the algorithm described by TABLE 2, only a single stay point is formed for this location. Hence, in an alternate embodiment, the stay point algorithm is modified to the one provided in TABLE 3. In this embodiment, if the time difference between the first and last measurement (duration of the stay point) is more than thetaₜ, then instead of adding a single stay point, multiple stay points are added. The number of stay points added is proportional to the duration of the stay point.

TABLE 3

```
Pseudo codes for modifying stay point detection
procedure StayPointDetection
  StayPoints: = Ø
  i := 0
  j := 1
  while i < numPoints do
    disp := distance (pⱼ, pⱼ₋₁)
    deltaₜ := pⱼ · T − pⱼ₋₁ · T
    $if ( \frac{disp}{{delta}_{t}} ) > {theta}_{dispt} then$
    i := j
    continue
  end if
  dist := distance (pᵢ, pⱼ)
  if dist ≥ theta_{d} then
  i := j
  else if pⱼ · T − pᵢ · T > thetaₜ then
    S.mCoord: = Compute MeanCoord ({pₖ|i ≤ k < j})
    S.arrT := pᵢ · T
    S. depT := pⱼ · T
    weight = floor((pⱼ · T − pᵢ · T)/thetaₜ)
    for w := 1: weight do
      Add S to StayPoints
    end for
    i := j
  end if
  j := j + 1
```

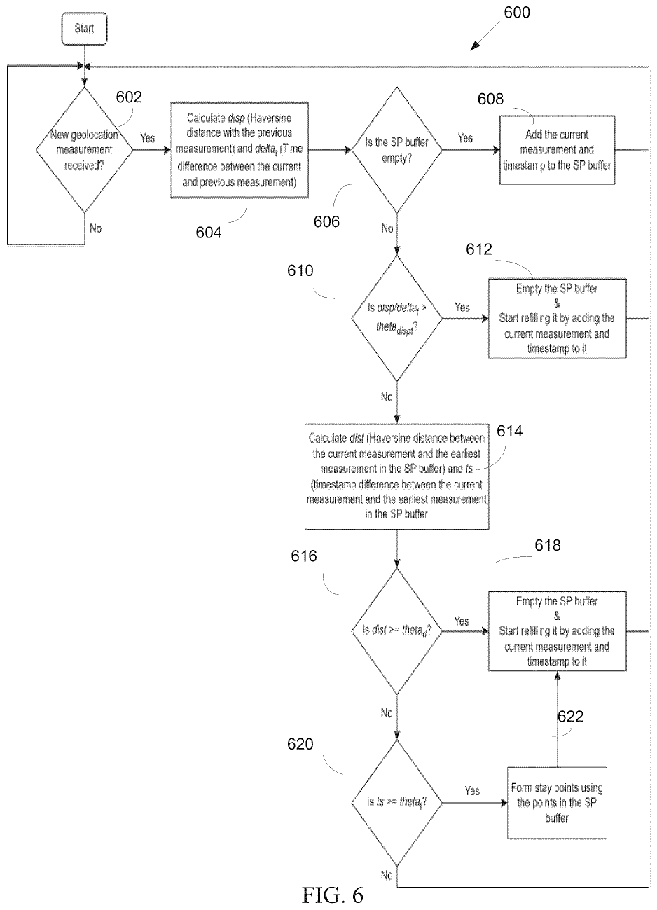

Based on this stay point detection algorithm, the online stay point detection using measurements received at a dynamic rate is performed using the solution shown in FIG. 6.

FIG. 6 illustrates a flowchart of a method 600 for online stay point detection according to various embodiments of the present disclosure. The method 600 may be performed by a network entity (e.g., 118 and 120 as illustrated in FIGS. 1 and 300 as illustrated in FIG. 3). An embodiment of the method 600 shown in FIG. 6 is for illustration only. One or more of the components illustrated in FIG. 6 can be implemented in a specialized circuitry configured to perform the noted functions or one or more of the components can be implemented by one or more processors executing instructions to perform the noted functions.

As illustrated in FIG. 6, the method 600 begins at step 602. In step 602, a network entity determines whether new geolocation measurement is received. In step 602, if the new geolocation measurement is received, the network entity calculates, in step 604, (i) Haversine distance with the previous measurement and (ii) time difference between the current and previous measurement. In step, 602, if not, the network entity rechecks an online detection of smartphone user's indoor location again. In step 606, the network entity determines whether the SP buffer is empty. In step 606, if the buffer is empty, the network entity adds the current measurement and timestamp to the SP buffer. In step 606, if the buffer is not empty, the network entity in step 610 determines whether the disp/deltaₜ is greater than theta_{dispt}. In step 610, the disp/deltaₜ is greater than theta_{dispt}, the network entity make the SP buffer empty and starts refilling it by adding the current measurement and timestamp to it in step 612. In step 610, if not, the network entity calculates dist and ts in step 614. In step 616, the network entity determines whether dist is greater than or equal to theta_{d}. In step 616, if dist is greater than or equal to theta_{d}, the network entity makes the SP buffer empty and starts refilling by adding the current measurement and timestamps to it in step 618. In step 616, if not, the network entity determines in step 620 whether ts is greater than or equal to thetaₜ. In step 620, if ts is greater than or equal to thetaₜ. The network entity forms stay points using the points in the SP buffer. In step 620, if not, the network entity performs step 602.

Once the stay points are obtained, POI clustering is performed to cluster the stay points into POIs. In one embodiment, DBScan, which is a density-based clustering approach, is used to cluster the stay points. In alternate embodiments, other clustering algorithms, for example k-means clustering, affinity propagation or OPTICS can be used. DBScan take two input parameters: (i) minPoints, which is the minimum number of stay points required to form a cluster and (ii) E, which is the minimum distance between two stay points for them to belong to the same cluster.

As per the requirement of the use case, different values for minPoints and e can be used.

In one embodiment, a POI is represented as a circular geometry. To represent the circular POI, for each cluster formed, the mean latitude and longitude (centroid) of all stay points forming the cluster along with the radius are stored as representatives of that POI. The radius of the POI is the distance of the centroid to the furthest stay point with the POI, as shown in FIG. 6. In an alternate embodiment, for each cluster formed, along with the mean latitude and longitude of the stay points and the radius, the stay points themselves are stored as well as the representatives of the POI.

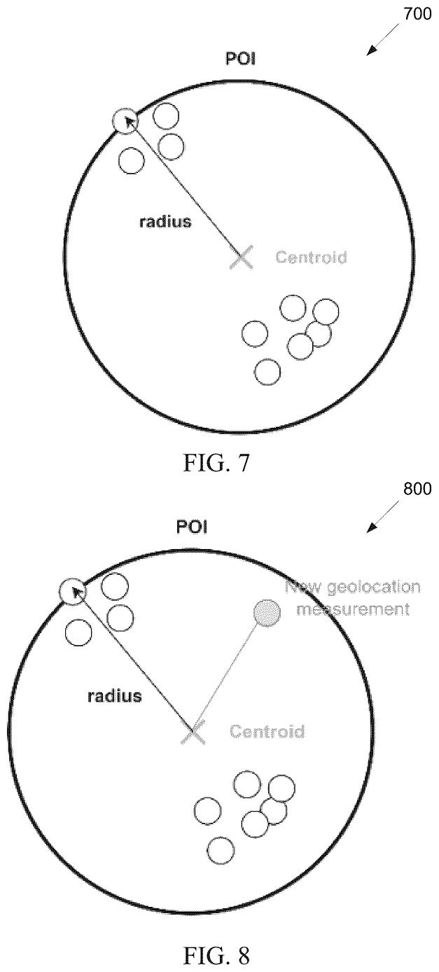

FIG. 7 illustrates an example of POI using the centroid of stay points and the radius 700 according to various embodiments of the present disclosure. An embodiment of the POI using the centroid of stay points and the radius 700 shown in FIG. 7 is for illustration only.

In one embodiment, other geometric shapes can be considered to represent the POI boundary.

Once clustering is performed, inference is performed on each new geolocation measurement received. During inference, there are these following possibilities for the geolocation measurement: (i) it could either belong to one of the existing clusters; (ii) it could form a new cluster, (iii) it could merge into an existing cluster, or (iv) it could lead to merging of two existing clusters.

In one embodiment, haversine distance of the geolocation measurement is calculated to the mean latitude and longitude of each cluster. The cluster with the minimum Haversine distance to the geolocation measurement is compared to a threshold. If the distance to the centroid of a cluster is less than the cluster radius, the measurement belongs to that cluster, as shown in FIG. 8. If the distance is more than the radius, the measurement is identified as an outlier. All the outliers are stored in an outlier buffer.

FIG. 8 illustrates an example of new measurement with distance from the centroid of the POI less than its radius 800 according to various embodiments of the present disclosure. An embodiment of the new measurement with distance from the centroid of the POI less than its radius 800 shown in FIG. 8 is for illustration only.

Stay point detection is performed on the outlier measurements in the outlier buffer as per the stay point detection algorithm. Any stay points that are formed from the outlier buffer are put into a stay point buffer and the outlier buffer is flushed. In the first embodiment, the outlier buffer is also flushed when a measurement is inferred as belonging to a cluster. If after adding any measurements to the outlier buffer, there is a measurement that is not outlier, this can distort the conditions of stay point detection in the outlier buffer, as next time an outlier is identified, the time difference between two consecutive outliers may not actually be the time difference between two consecutive measurements.

In one embodiment, before adding the stay points to the stay point buffer, a check is performed to see if the stay point can be merged with an existing cluster. If the stay point lies close enough to a cluster, it is merged with that cluster and the cluster boundary is expanded.

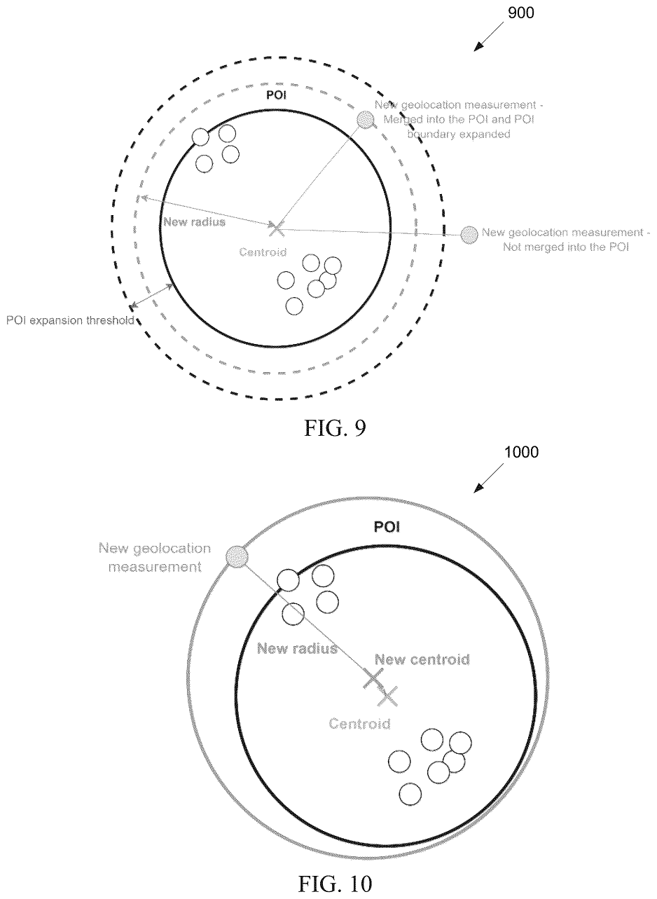

In one embodiment which stores only the centroid of stay points as the representatives of the clusters, to check if a stay point may be merged with an existing cluster, the distance of the stay point with the centroid of the cluster is calculated. If the stay point is within a certain threshold from the cluster boundary, which means that the distance of the stay point from the centroid of the cluster is within a certain threshold, the stay point is merged with the cluster or POI, and the POI radius is updated, as shown in FIG. 9. The new radius of the POI is the distance of this stay point from the centroid of the POI.

FIG. 9 illustrates an example of new geolocation measurement merging into the POI 900 when only centroid and radius are stored as representative of the POI according to various embodiments of the present disclosure. An embodiment of the new geolocation measurement merging into the POI 900 shown in FIG. 9 is for illustration only.

In one embodiment which stores the stay points themselves along with their centroids, to check if a stay point may be merged with an existing cluster, the distance of the stay point is calculated to all the stay points within the cluster. If the minimum distance to a stay point in the cluster is below a certain threshold, the stay point is merged with the cluster. The new centroid of the POI is calculated using the updated list of stay points of this POI which includes this new stay point. The new radius of the POI is the distance of the centroid from the furthest stay point, as shown in FIG. 10.

FIG. 10 illustrates an example of new geolocation measurement merging into the POI 1000 when the stay points along with the centroid and radius are stored as representative of the POI according to various embodiments of the present disclosure. An embodiment of the new geolocation measurement merging into the POI 1000 shown in FIG. 10 is for illustration only.

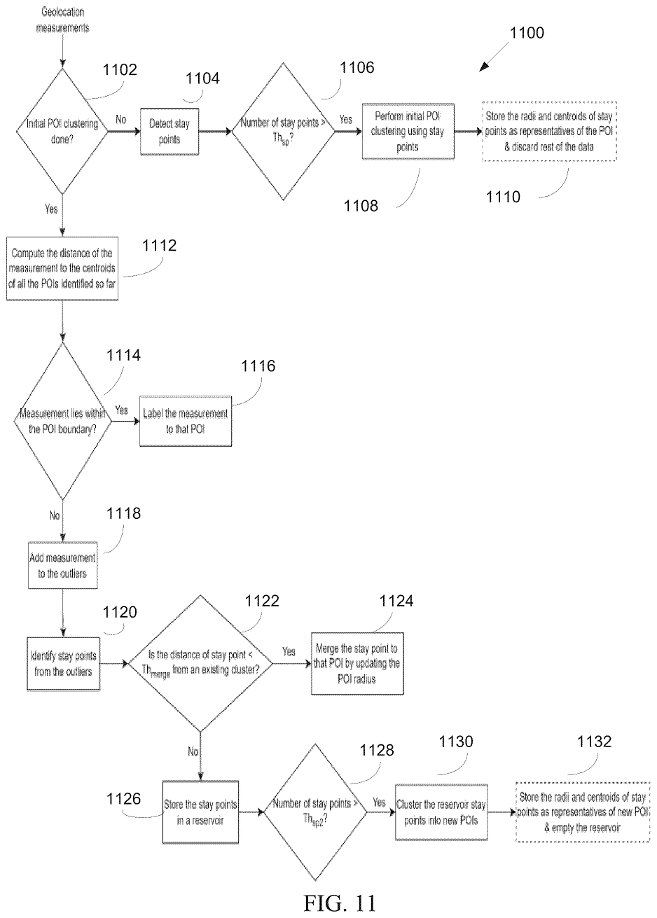

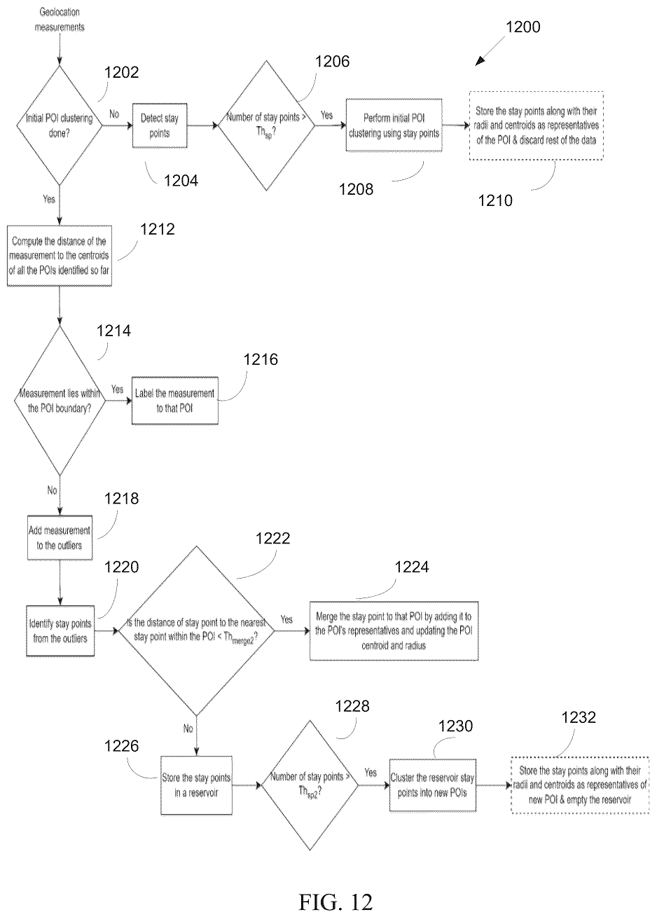

When sufficient number of stay points are accumulated in the buffer, re-clustering is performed using the stay points in the stay point buffer and new clusters are formed. The block diagram of the overall online primary location clustering and inference solution that stores the centroids and radii of the stay points as representatives of the POI is shown in FIG. 11 and the one that stores the stay points along with the centroids and radii as representatives of the POI is shown in FIG. 12.

FIG. 11 illustrates a flowchart of a method 1100 for an online primary location clustering and detection solution that stores only the centroids and radius of the stay points as representatives of POI according to various embodiments of the present disclosure. The method 1100 may be performed by a network entity (e.g., 118 and 120 as illustrated in FIG. 1 and a network entity 300 as illustrated in FIG. 3). An embodiment of the method 1100 shown in FIG. 11 is for illustration only. One or more of the components illustrated in FIG. 11 can be implemented in a specialized circuitry configured to perform the noted functions or one or more of the components can be implemented by one or more processors executing instructions to perform the noted functions.

As illustrated in FIG. 11, the method 1100 begins at step 1102. In step 1102, a network entity determines, based on geolocation measurements, whether initial POI clustering is performed. In step 1102, if it is not performed, the network entity in step 1104 detects stay points. In step 1106, the network entity determines whether a number of stay points is greater than Thₛₚ. In step 1106, if a number of stay points is greater than Thₛₚ, the network entity performs initial POI clustering using stay points in step 1108. The network entity in step 1110 stores the radii and centroids of stay points as representatives of the POI and discard rest of the data. In step 1102, if it is performed, the network entity computes the distance of the measurement to the centroids of all the POIs identified so far in step 1112. In step 1114, the network entity determines whether the measurement lies within the POI boundary. In step 1114, if the measurement lies within the POI boundary, the network entity labels the measurement to that POI in step 1116. In step 1114, if not, the network entity adds measurement to the outliers in step 1118. In step 1120, the network entity identifies stay points from the outliers. In step 1122, the network entity determines whether the distance of stay point is less than Th_{merge} from an existing cluster. In step 1122, if the distance is less than Th_{merge}, the network entity in step 1124 merges the stay point to that POI by updating the POI radius. In step 1122, if not, the network entity stores the stay points in a reservoir in step 1126. In step 1128, the network entity determines whether a number of stay points is greater than Thₛₚ₂. In step 1128, if the number of stay points is greater than Thₛₚ₂, the network entity clusters the reservoir stay points into new POIs in step 1130. Finally, the network entity in step 1132 stores the radii and centroids of stay points as representatives of new POI and make the reservoir empty.

FIG. 12 illustrates a flowchart of a method 1200 for an online primary location clustering and detection solution that stores the stay points along with their centroids and radius as representatives of POI according to various embodiments of the present disclosure. The method 1200 may be performed by a network entity (e.g., 118 and 120 as illustrated in FIG. 1 and a network entity 300 as illustrated in FIG. 3). An embodiment of the method 1200 shown in FIG. 12 is for illustration only. One or more of the components illustrated in FIG. 12 can be implemented in a specialized circuitry configured to perform the noted functions or one or more of the components can be implemented by one or more processors executing instructions to perform the noted functions.

As illustrated in FIG. 12, the method 1200 begins at step 1202. In step 1202, a network entity determines, based on geolocation measurement, whether initial POI clustering is performed. In step 1202, if it is not performed, the network entity in step 1204 detects stay points. In step 1206, the network entity determines whether a number of stay points is greater than Thₛₚ. In step 1206, if the number of stay points is greater than Thₛₚ, the network entity performs initial POI clustering using stay points in step 1208. The network entity in step 1210 stores the stay points along with their radii and centroids of stay points as representatives of the POI and discards rest of the data. In step 1202, if it is performed, the network entity computes the distance of the measurement to the centroids of all the POIs identified so far in step 1212. In step 1214, the network entity determines whether the measurement lies within the POI boundary. In step 1214, if the measurement lies within the POI boundary, the network entity labels the measurement to that POI in step 1216. In step 1214, if not, the network entity adds measurement to the outliers in step 1218. In step 1220, the network entity identifies stay points from the outliers. In step 1222, the network entity determines whether the distance of stay point to the nearest stay point with the POI is less than Th_{merge2}. In step 1222, if the distance is less than Th_{merge2}, the network entity in step 1224 merges the stay point to that POI by adding it to the POI's representatives and updates the POI centroid and radius. In step 1222, if not, the network entity stores the stay points in a reservoir in step 1226. In step 1228, the network entity determines whether a number of stay points is greater than Thₛₚ₂. In step 1228, if the number of stay points is greater than Thₛₚ₂, the network entity clusters the reservoir stay points into new POIs in step 1230. Finally, the network entity in step 1232 stores the stay points along with their radii and centroids as representatives of new POI and make the reservoir empty.

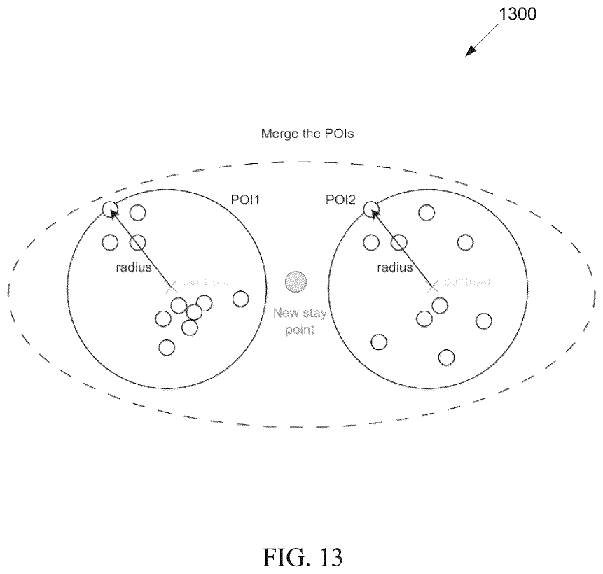

In one embodiment, a new stay point can also result in merging of two or more existing POIs. This can happen when the stay points of two or more POIs are not close enough to form a single cluster, resulting in forming of two or more separate clusters for them. When a new stay point is formed, which is close enough to both the clusters, merging of these POIs can be performed as shown in FIG. 13.

FIG. 13 illustrates an example of criteria to merge the POIs 1300 according to various embodiments of the present disclosure. An embodiment of the criteria to merge the POIs 1300 shown in FIG. 13 is for illustration only.

In one embodiment which stores only the centroid of stay points as the representatives of the clusters, the distance of the new stay point is calculated to the centroids of all the POIs. If there are multiple POIs (more than one) to which the distance of the new stay point is below a threshold, the POIs are merged. In an alternate embodiment which stores the stay points themselves along with their centroids, the distance of the stay point is calculated to all the stay points within the existing POIs. If the distance of the new stay point to the nearest stay point within multiple clusters is below a threshold, the POIs are merged.

Sometimes it may happen that the user visits a place, for example a café or grocery store or a diner, and stay there for a sufficiently long time to form multiple stay points sufficient to form a new POI. However, it may be possible that the user does not visit there often or ever again. Hence, that location may not be a POI, but only since the user spent a long enough time at that location once made it into a POI. To avoid forming a POI for less frequently or rarely visited places, in one embodiment, there are two buffers maintained for clustered POIs. Whenever a new POI is clustered, either after initial clustering or clustering from reservoir, the clustered POI is first added to the temporary buffer. There is a counter, NumberOfVisits, maintained for each POI in the temporary buffer and it represents the number of times the POI is visited. Whenever there is a new location measurement received, it is compared against the POIs in the temporary buffer. If the measurement belongs to an existing POI, it waits until the user exits the POI, that is last until it receives a measurement which is not inside this POI. After then it increments the NumberOfVisits counter for this POI. When the counter for a particular POI exceeds a threshold, only then the clustered POI is moved from temporary buffer to the permanent buffer. Permanent buffer stores the final clustered POIs. Hence, the inference of new GPS locations, decision to expand a POI or merge the POIs is performed using the POIs in the permanent buffer. The inference on POIs in temporary buffer may increase the NumberOfVisits counter.

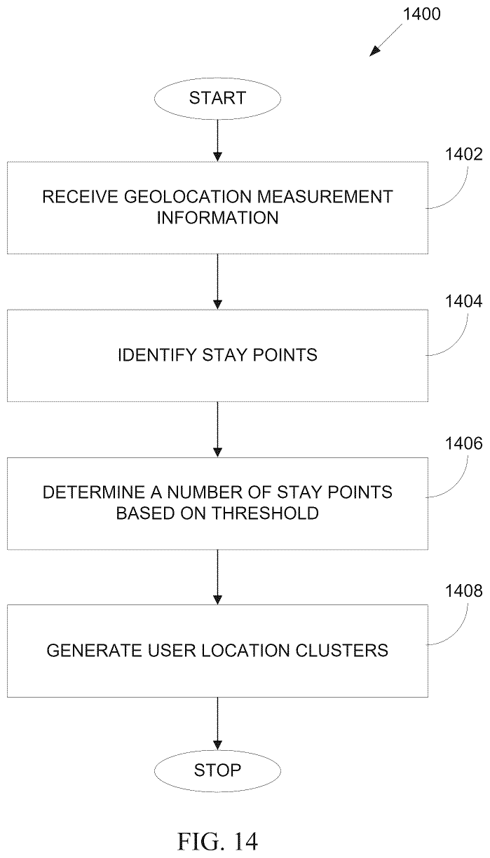

FIG. 14 illustrates a flowchart of a method 1400 for an online detection of smartphone user's primary location according to various embodiments of the present disclosure. The method 1400 may be performed by a network entity (e.g., 118 and 120 as illustrated in FIG. 1). An embodiment of the method 1400 shown in FIG. 14 is for illustration only. One or more of the components illustrated in FIG. 14 can be implemented in a specialized circuitry configured to perform the noted functions or one or more of the components can be implemented by one or more processors executing instructions to perform the noted functions.

As illustrated in FIG. 14, the method 1400 beings at step 1402. In step 1402, a network entity receives, from a UE, geolocation measurement information.

Subsequently, the network entity in step 1404 identifies stay points based on the geolocation measurement information, wherein the geolocation measurement information is received at a non-uniform dynamic rate associated with a motion of a user.

Next, in step 1406, the network entity determines, based on the geolocation measurement information, whether a number of stay points exceeds a threshold.

Finally, in step 1408, the network entity generates user location clusters based on a determination that the number of stay points exceeds the threshold.

In one embodiment, the network entity identifies new user location clusters, expands the user location clusters to include at least one user location cluster, or merges at least two user location clusters to form the user location clusters based on a centroid and a radius of the at least two user location clusters.

In one embodiment, the network entity receives, from the UE, new geolocation measurement information, identifies, based on the new geolocation measurement information, a user location cluster among the user location clusters, the user location cluster being associated with the new geolocation measurement information, and determines whether the geolocation measurement information belongs to a valid user location cluster.

In such embodiments, the geolocation measurement information that does not belong to the valid user location cluster is added to an outlier.

In one embodiment, the network entity identifies a new stay point based on a determination that the geolocation measurement information belongs to an outlier and determines, based on the new stay point, whether to perform a re-clustering operation.

In one embodiment, the network entity fetches the geolocation measurement information with new geolocation measurement information to identify the stay points when a location of a user changes with a minimum rate interval.

In such embodiments, the minimum rate interval is identified based on at least one of: a time period when the user stays at a same location, a movement of the user from the same location, or a movement speed of the user, the geolocation measurement information being constantly generated at a rate that is proportional to the movement speed of the user.

In one embodiment, the network entity identifies a distance between two points and a timestamp difference between two points, determines whether the distance is lower than a distance threshold, whether the timestamp difference is higher than a time threshold, and whether a ratio of the distance and the timestamp difference is lower than a speed threshold, and stores the two points in a buffer for the stay points based on a determination that the distance is lower than a distance threshold, the timestamp difference is higher than a time threshold, and the ratio of the distance and the timestamp difference is lower than the speed threshold.

In one embodiment, the network entity identifies a minimum Haversine distance of the geolocation measurement information to compare with a threshold, identifies the geolocation measurement information belongs to a valid cluster based on a determination that the minimum Haversine distance is less than a radius of the valid cluster, and identifies the geolocation measurement information belongs to an outlier based on a determination that the minimum Haversine distance is greater than the radius of the valid cluster and store the geolocation measurement information to an outlier buffer.

In such embodiments, an inference operation is performed, based on a Haversine distance of the geolocation measurement information, to identify a mean latitude and a mean longitude of each cluster.

In one embodiment, the network entity merges a stay point with at least one current user location cluster when: a minimum distance of the user location cluster center to the stay point is below a threshold; a new centroid of a point of interest (POI) calculated based on an updated list of the stay points of the POI includes a new stay point; and a radius of the POI is a distance of a centroid from a furthest stay point among the stay points of the POI includes a new stay point.

In one embodiment, the network entity merges at least two POIs when: a new stay point is identified between at least two clusters; at least two POIs to which a distance of the new stay point is less than a threshold. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A network entity in a wireless communication system, the network entity comprising:
a transceiver configured to receive, from a user equipment (UE), geolocation measurement information; and
a processor operably coupled to the transceiver, the processor configured to:
identify stay points based on the geolocation measurement information, wherein the geolocation measurement information is received at a non-uniform dynamic rate associated with a motion of a user,
determine, based on the geolocation measurement information, whether a number of stay points exceeds a threshold, and
generate user location clusters based on a determination that the number of stay points exceeds the threshold.

2. The network entity of claim 1, wherein the processor is further configured to perform, based on the geolocation measurement information, at least one of an operation to:
identify new user location clusters;
expand the user location clusters to include at least one user location cluster; or
merge at least two user location clusters to form the user location clusters based on a centroid and a radius of the at least two user location clusters.

3. The network entity of claim 1, wherein:
the transceiver is further configured to receive, from the UE, new geolocation measurement information; and
the processor is further configured to:
identify, based on the new geolocation measurement information, a user location cluster among the user location clusters, the user location cluster being associated with the new geolocation measurement information, and
determine whether the geolocation measurement information belongs to a valid user location cluster,
wherein the geolocation measurement information that does not belong to the valid user location cluster is added to an outlier.

4. The network entity of claim 3, wherein the processor is further configured to:
identify a new stay point based on a determination that the geolocation measurement information belongs to an outlier; and
determine, based on the new stay point, whether to perform a re-clustering operation.

5. The network entity of claim 1, wherein the processor is further configured to fetch the geolocation measurement information with new geolocation measurement information to identify the stay points when a location of a user changes with a minimum rate interval, and
wherein the minimum rate interval is identified based on at least one of:
a time period when the user stays at a same location,
a movement of the user from the same location, or
a movement speed of the user, the geolocation measurement information being constantly generated at a rate that is proportional to the movement speed of the user.

6. The network entity of claim 5, wherein the processor is further configured to:
identify a distance between two points and a timestamp difference between two points, determine whether the distance is lower than a distance threshold, whether the timestamp difference is higher than a time threshold, and whether a ratio of the distance and the timestamp difference is lower than a speed threshold; and
store the two points in a buffer for the stay points based on a determination that the distance is lower than a distance threshold, the timestamp difference is higher than a time threshold, and the ratio of the distance and the timestamp difference is lower than the speed threshold.

7. The network entity of claim 6, wherein:
the processor is further configured to:
identify a minimum Haversine distance of the geolocation measurement information to compare with a threshold,
identify the geolocation measurement information belongs to a valid cluster based on a determination that the minimum Haversine distance is less than a radius of the valid cluster, and
identify the geolocation measurement information belongs to an outlier based on a determination that the minimum Haversine distance is greater than the radius of the valid cluster and store the geolocation measurement information to an outlier buffer; and
wherein an inference operation is performed, based on a Haversine distance of the geolocation measurement information, to identify a mean latitude and a mean longitude of each cluster.

8. The network entity of claim 1, wherein the processor is further configured to merge a stay point with at least one current user location cluster when:
a minimum distance of a user location cluster center to the stay point is below a threshold;
a new centroid of a point of interest (POI) calculated based on an updated list of the stay points of the POI includes a new stay point; and
a radius of the POI is a distance of a centroid from a furthest stay point among the stay points of the POI includes a new stay point.

9. The network entity of claim 1, wherein the processor is further configured to merge at least two POIs when:
a new stay point is identified between at least two clusters; and
at least two POIs to which a distance of the new stay point is less than a threshold.

10. A method of a network entity in a wireless communication system, the method comprising:
receiving, from a user equipment (UE), geolocation measurement information;
identifying stay points based on the geolocation measurement information, wherein the geolocation measurement information is received at a non-uniform dynamic rate associated with a motion of a user;
determining, based on the geolocation measurement information, whether a number of stay points exceeds a threshold; and
generating user location clusters based on a determination that the number of stay points exceeds the threshold.

11. The method of claim 10, further comprising at least one of:
identifying new user location clusters;
expanding the user location clusters to include at least one user location cluster; or
merging at least two user location clusters to form the user location clusters based on a centroid and a radius of the at least two user location clusters.

12. The method of claim 10, further comprising:
receiving, from the UE, new geolocation measurement information;
identifying, based on the new geolocation measurement information, a user location cluster among the user location clusters, the user location cluster being associated with the new geolocation measurement information; and
determining whether the geolocation measurement information belongs to a valid user location cluster,
wherein the geolocation measurement information that does not belong to the valid user location cluster is added to an outlier.

13. The method of claim 12, further comprising:
identifying a new stay point based on a determination that the geolocation measurement information belongs to an outlier; and
determining, based on the new stay point, whether to perform a re-clustering operation.

14. The method of claim 10, further comprising fetching the geolocation measurement information with new geolocation measurement information to identify the stay points when a location of a user changes with a minimum rate interval,
wherein the minimum rate interval is identified based on at least one of:
a time period when the user stays at a same location,
a movement of the user from the same location, or
a movement speed of the user, the geolocation measurement information being constantly generated at a rate that is proportional to the movement speed of the user.

15. The method of claim 14, further comprising:
identifying a distance between two points and a timestamp difference between two points,
determining whether the distance is lower than a distance threshold, whether the timestamp difference is higher than a time threshold, and whether a ratio of the distance and the timestamp difference is lower than a speed threshold; and
storing the two points in a buffer for the stay points based on a determination that the distance is lower than a distance threshold, the timestamp difference is higher than a time threshold, and the ratio of the distance and the timestamp difference is lower than the speed threshold.

16. The method of claim 15, further comprising:
identifying a minimum Haversine distance of the geolocation measurement information to compare with a threshold;
identifying the geolocation measurement information belongs to a valid cluster based on a determination that the minimum Haversine distance is less than a radius of the valid cluster; and
identifying the geolocation measurement information belongs to an outlier based on a determination that the minimum Haversine distance is greater than the radius of the valid cluster and store the geolocation measurement information to an outlier buffer,
wherein an inference operation is performed, based on a Haversine distance of the geolocation measurement information, to identify a mean latitude and a mean longitude of each cluster.

17. The method of claim 10, further comprising merging a stay point with at least one current user location cluster when:
a minimum distance of a user location cluster center to the stay point is below a threshold;
a new centroid of a point of interest (POI) calculated based on an updated list of the stay points of the POI includes a new stay point; and
a radius of the POI is a distance of a centroid from a furthest stay point among the stay points of the POI includes a new stay point.

18. The method of claim 10, further comprising merging at least two POIs when:
a new stay point is identified between at least two clusters; and
at least two POIs to which a distance of the new stay point is less than a threshold.

19. A user equipment (UE) in a wireless communication system, the UE comprising:
a processor configured to generate geolocation measurement information, wherein stay points are identified based on the geolocation measurement information; and
a transceiver operably coupled to the processor, the transceiver configured to transmit, to a network entity, the geolocation measurement information,
wherein the geolocation measurement information is transmitted at a non-uniform dynamic rate associated with a motion of a user,
wherein whether a number of stay points exceeds a threshold is determined based on the geolocation measurement information, and
wherein user location clusters is identified based on a determination that the number of stay points exceeds the threshold.

20. The UE of claim 19, wherein:
the transceiver is further configured to transmit, to the network entity, new geolocation measurement information;
based on the new geolocation measurement information, a user location cluster among the user location clusters is identified, the user location cluster being associated with the new geolocation measurement information;
whether the geolocation measurement information belongs to a valid user location cluster is determined; and
the geolocation measurement information that does not belong to the valid user location cluster is added to an outlier.
